(19) United States
(12) Patent Application Publication
(10) Pub. No.: US 2013/0133034 A1
(43) Pub. Date: May 23, 2013

(54) SYSTEMS AND METHODS FOR CREATING A TRUST INDEX WITH RESPECT TO ONLINE IDENTITIES

(71) Applicants: Jonathan Strietzel, Lakewood, CA (US); Theodore Agranat, Sammamish, WA (US)

(72) Inventors: Jonathan Strietzel, Lakewood, CA (US); Theodore Agranat, Sammamish, WA (US)

(21) Appl. No.: 13/671,464

(22) Filed: Nov. 7, 2012

Related U.S. Application Data
(60) Provisional application No. 61/556,718, filed on Nov. 7, 2011.

(51) Int. Cl. H04L 29/06

(52) U.S. Cl. CPC H04L 63/102
USPC 726/3

(57) ABSTRACT

A user verification engine that will verify trust worthiness (trust-level) of individuals and through that trust-level of content they produce online is disclosed herein.

### RELATED APPLICATIONS INFORMATION

This application claims benefit of priority of U.S. Provisional Application No. 61/556,718, filed on Nov. 7, 2011 and entitled “Systems and Methods for Creating a Trust Index with Respect to Online Identities,” which is incorporated herein by reference.

### BACKGROUND

1. Technical Field

The embodiments described herein are related to online content creation, and more particularly to systems and methods for understand whether a source of online content can be trusted.

2. Related Art

The social network revolution is well underway. Sites like Facebook, Twitter, LinkedIn®, MySpace, Google+, Tagged, Friendster®, and others have become not only common tools but are fast becoming an entire new community and creating new economies. In fact, the above list does not even include game sites such as Zynga or sites like Wikipedia, which in effect are social networking sites since they bring a large community of people together to interact. Initially, such sites originated as communities in which friends and contacts could stay connected. For example, in essence, Facebook, the most popular of these sites was little more than an email program with very good spam filtering. But now, Facebook has transformed itself into a commerce platform where all types of information, content, applications, etc., can be exchanged and purchased.

One example of how social networking is changing traditional commerce is evidenced by the fact that many businesses have Facebook and LinkedIn pages, Twitter accounts, blogs, etc. In addition, social networks are increasingly being sued to rate companies or products, share information both good and bad about companies, products, individuals, really anything. In fact, the impact of these types of activities is such that today a business or professional needs to constantly monitor their online profile to be sure that no one is creating a negative online impression of the business or professional.

But the power of these types of activities can also be abused. While the extent is unknown, it is universally agreed that many individuals and companies create false information or impressions on the Internet in order influence their own image or that of a competitor's. For example, teams of individuals are often employed to write comments on blogs and other sites promoting a company or criticizing its competitors. Not only can this activity affect other people's views, the creation of large amounts of data about a company can influence where that company shows up in Internet search results on engines such as Google's. It has been shown for example that very view people ever click past the second page of search results, and only a fraction even go past page one. Accordingly, it can be very valuable to be on page one.

The fact is, most reviews online are fake. A business can purchase reviews for, e.g., $10 for 250 words from groups operating out of, e.g., India and Philippines. Many companies world wide specialize in efforts to a) manipulate search engine rankings, and b) manipulate user sentiment. Even honest reviews have the problem that readers do not know if the person providing the review has enough expertise and experience to write a relevant review or not. For example, if there are 95 negative and 5 positive reviews for running shoes, one would likely conclude that the shoe is not very good. But if one knew that the 95 bad reviews are from amateurs who, e.g., may not have liked the color and used the shoes once a week, but that the 5 positive reviews are from professionals that are running daily, then one would be much more likely to have a positive view of the shoe.

Many Internet users today still basically rely on the order of search results to determine what is relevant and what isn't. But, search engine optimization techniques allow companies to manipulate the rankings significantly, and as such trust in such rankings, and therefore satisfaction with search engine performance is waning.

Part of the problem is that there typically is no control over who posts information or what is posted. Traditional media for example typically uses very detailed interview processes, fact checking, source verification, etc., before something is published and before a writer would be allowed to address a large audience of the magazine. But with the Internet, anyone can launch a blog or a website and users have no way of verifying the accuracy of what is written or the experience level of the author beyond the bold unverified claims that many authors make.

Other examples of the lack of trust that exist include the fact that users of sites like Craigslist have no way of verifying the trust worthiness of sellers on Craigslist, and even Facebook and Twitter these days are littered with fake profiles used to spam Google and other search engines.

While many conventional sites and search engines attempt to detect phony data, the truth is it can be very difficult and some estimates put the amount of phony data on the Internet at as much as 50%. With more and more people turning to the Internet for information and more and more companies and professionals dependent on the Internet for success, this type of fraudulent activity can have a very negative impact.

### SUMMARY

A user verification engine that will verify trust worthiness (trust-level) of individuals and through that trust-level of content they produce online is disclosed herein.

These and other features, aspects, and embodiments are described below in the section entitled “Detailed Description.”

### BRIEF DESCRIPTION OF THE DRAWINGS

Features, aspects and embodiments are described in conjunction with the attached drawings, in which:

FIG. 1 is a diagram illustrating an example embodiment of a system of 100 for verifying the trust level of individuals in accordance with one embodiment;

FIG. 2 is a flow chart illustrating an example process for how a trust score can be created in accordance with one embodiment; and

FIG. 3 illustrates a radio graph that can be used to indicate where the user is strong and where they are weak in terms of the factors that go into the trust score.

### DETAILED DESCRIPTION

The embodiments described below are related to the development of a system for verifying the trust worthiness of individuals and through this trust level the reliability of the content they produce online. In certain embodiments, the concept of expertise is also integrated such that other users can discern not only whether the person is trustworthy, but also whether they have any expertise with respect to the content being produced.

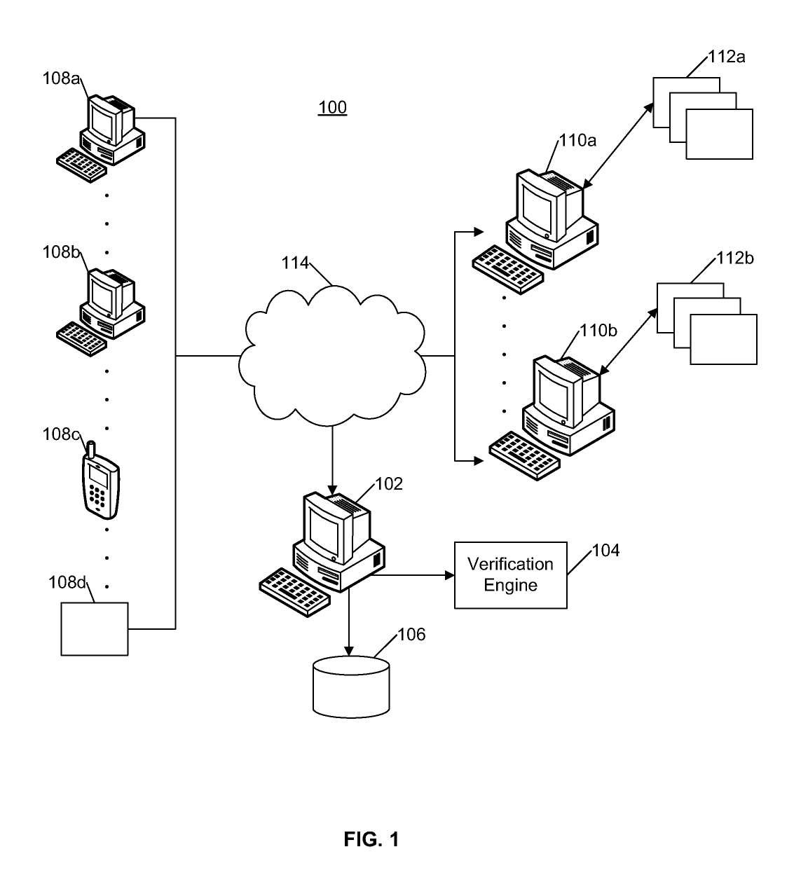

FIG. 1 is a diagram illustrating an example embodiment of a system 100 for verifying the trust level of individuals in accordance with one embodiment. System 100 includes a verification server 102, which includes or is interfaced with a verification engine 104, and a database 106. It will be understood that term server can refer to all of the hardware and software systems needed to implement the systems and methods described herein. As such, it will be understood that the term server can refer to multiple servers, routers, user interfaces, programs, applications, API's, etc., and that these components can be located in one location or multiple locations. It particular, verification engine can be a set of algorithms, routines, processes, programs, instructions, etc., configured to run on and under the control of server 102.

In system 100, users can access server 102 in order to be verified. For example the users can access server 102 using a user terminal 108a-d. The term terminal can refer to a computer such as a laptop or desktop computer, or a portable computing device, such as a tablet, cell phone, smart phone, personal digital assistant, etc. Once the user has accessed server 120, they can provide information that can be used to develop an identity, or trust score. In certain embodiments, the user can create an account on server 102 in order to manage their profile with respect to their trust score.

The trust score can be included in a “trust badge” that can be “attached” to the user, or their device 108 such that when they access sites, e.g., hosted by server 110, and post information the trust badge or sign can be displayed in connection with their name allowing other users to asses their trustworthiness, and in certain embodiments their expertise.

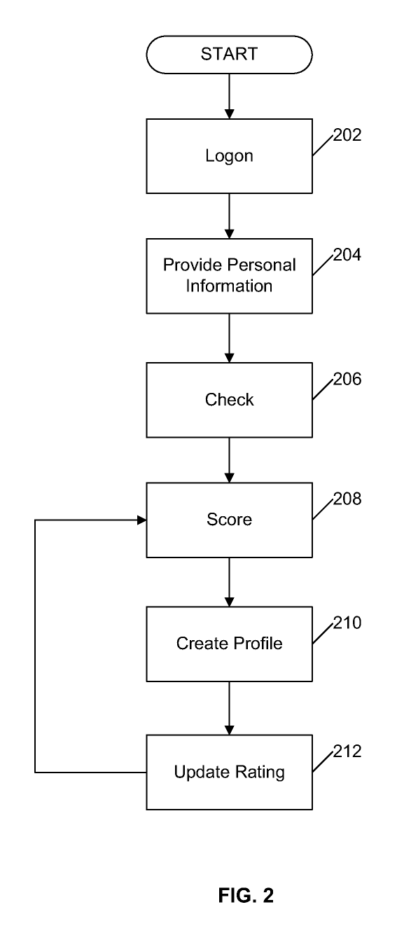

FIG. 2 is a flow chart illustrating an example process for hot a trust score can be created in accordance with one embodiment. First, in step 202, a user can log onto server 102. Then, in step 204, the user can provide various personal and demographic information. This information is used in step 206 by verification engine to verify the trustworthiness of the user. A trust score can then be created based in the verification or the degree of verification as discussed in detail below. A profile can then created for the user in step 210. The profile and the information provided can then be updated over time in step 212, and a new score can then be generated.

The information provided in step 204 can include various forms of information including name, age, race, sex, address, occupation, employer, social security number, drivers license number, credit information, organizational memberships, IP address, etc. The more information that is provided, i.e., the more variables that can be used by verification engine 104, the better the verification and potentially the higher the trust score.

Obviously, some of this information is sensitive and confidential and therefore, in certain implementations not all of these variables will be used. In implementations that do use some of the more sensitive information, then security measures are employed in order to secure the information. It should also be apparent the list of information provided is by way of example only and that other types of information can also be used.

Verification engine 104 can be configured to then verify the information provided. This can include communicating with various systems and databases to verify the information provided. In addition, verification engine 104 can be configured to check the web presence and information available on the Internet to cross check the information provided by the user as well as the post and content created by the user.

Once a score has been generated, and the user starts to post information, then the score can be updated based on the posts and content created. In other words, the information created by a user online can be evaluated in order to determine the trustworthiness of user. Similarly, the users expertise can be similarly evaluated, i.e., the user's post and content can be evaluated in order to rate their expertise. The expertise can then either be appended to or included in the trust score. For example, if a user has been evaluated as having expertise with respect to fishing, the posts or content created can be rated or scored highly. But if they post information or content related to economics, then their expertise level or score can be lower.

In certain embodiments, other users can rate the trustworthiness and/or expertise. In other words, users who know the individual can indicate their level of knowledge of the individual and give an indication of how confident they are that the individual is trustworthy. Individual's who are familiar with the individual's posts and content can rate the trustworthiness of the individual based on the trustworthiness, accuracy, etc., of pervious posts.

A user's score can therefore be based on numerous aspects. The more aspects, and the more verifiable or trustworthy the source of those aspects, the higher the individual's score. For example, a verification of the user's social security number can weigh more than a rating by another user.

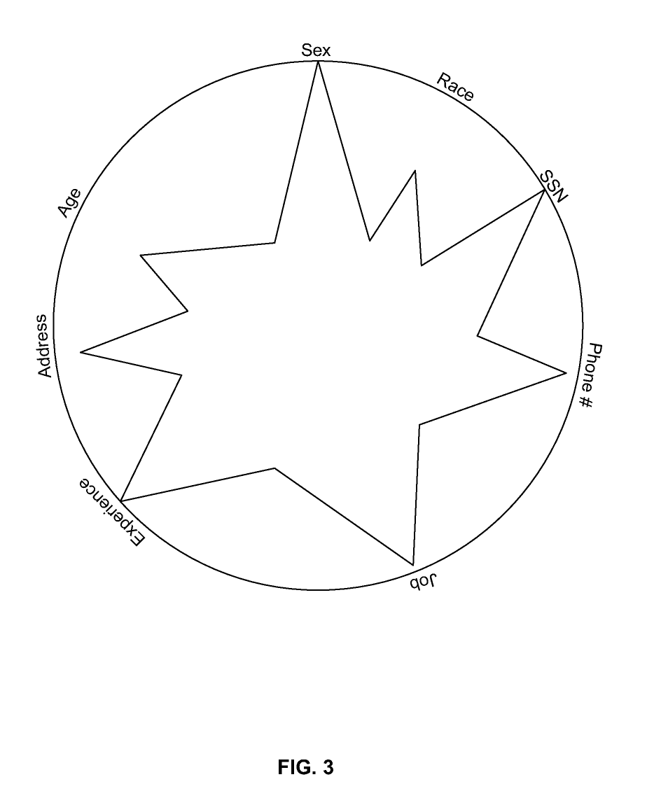

In certain embodiments, the user can manage their score. For example, the user can access a site and see what there score is. The user can then work, by creating more posts, inputting more information, providing ratings of other users, etc., to raise their score. For example, a radio graph such as the one illustrated in FIG. 3 can be used to indicate where the user is strong and where they are weak in terms of the factors that go into the trust score. The user can then work on items that are weak and track the progress.

In certain embodiments, the user can be rewarded for obtaining certain trust score levels. For example, when they reach a certain score, they may be able to then rate other users, which can further enhance their score. There can also be prizes and other recognition.

The level of verification needed, and the number of authentication items required can be based on the level of trust needed, e.g., a product review, for example, needs less authentication and needs to be more experience focused than access to medical records online, which can require social security number, drivers license, etc.

When the user appears online, a badge indicating their level of trustworthiness can appear next to their name or other presence indicator. Moreover, when they post content, their badge or other trustworthiness identifier can be appended to the content. Thus, a cookie can be used to store the readers trustworthiness badge or information so that when the user accesses a cite they the information can be retrieved and appended to the presence indicator being used. This information can also be embedded into the meta data of content being posted. The attachment of the trustworthiness data can also be accomplished via a browser overlay. This could all be done as a browser plug-in.

In certain embodiments, the user can have multiple identities (work, personal, student life etc), such that different information is used and available to different groups of people in different settings. Thus, each identity can have a different score or the same score can be used across all identities but with access to only certain information relevant to the score. The management of these identities can be done in one of several ways, i.e., they can all be treated as independent accounts, which can possibly be linked together, or they can be one account with different identities to be used in different environments.

Further, a multi-faceted identity profile can allow a user to have one profile but allow access only to a limited number of data points, e.g., on reviews schooling may not be as relevant as current hobby, etc. Management and linking of data across accounts can give a broader and more intense perspective of who each user is. For example, a key list of genes can be used for an “Entrepreneur” and a key list of genes for a “Club Hopper/Rave” person. These genes can be used to build different identities for different needs, environments, etc., but there may be a few genes in each that are the same. These overlaps can also be useful information used to create an overall identity and trustworthiness score, not just for the individual but across a population as well.

A single sign-on to web can be used across multiple providers or portals that incorporate the identity, and trustworthiness information or badge. These providers can connect to an API to attach the data to every user on single sign-on.

Corporate accounts generally cannot be verified like regular users on Facebook for example. In certain embodiments, corporate databases can be searched specifically to verify the identity and trustworthiness of the corporate users. Users that have corporate accounts can also be linked to their personal accounts, which should provide a more relevant link between what would otherwise be potentially unlinked accounts. A validated job correlated with a personal account can provide a lot of information about the user and sets that person apart from the average unverified user.

In certain embodiments, the user can experience customization based on the badge rank/trust rank, which as noted above can provide access to exclusive events, bigger rewards on credit cards, discounts at stores, etc. Also, as referred to above users can rate others and become known as a influencer of trust rank. In other words, if someone's rankings of others are particularly accurate, useful, etc., then they can also have an influencer rating or rank. The customization referred to above can then also be based on how much of an influencer the user is on top of trust rank. For example, how many posts per day does a user have, how many comments to are added to the user's posts, how many friends, likes, followers etc, can all be used to determine a user's influence.

An expertise rank can also be used to customize the advertising targeted at the user if the user agrees to that (opts in). In other words, the trust ranking can be viewed as a game: point-based systems, virtual currency systems and such are very hot and ultimately are needed as one of the tools that keep a site or service sticky. There can also be a leveling up system where users earn different “Degrees” of trust.

All of the user information can be stored in the cloud to sync to ALL of a users devices no matter what they use and where—so identities and their multifaceted experience/trust badge can be mapped to any device. In fact, in certain embodiments, a user can “Link” a device to their TrustSocial account and that device then becomes a “TrustedDevice”. The device's unique identifiers, e.g., telephone number, serial number, MIN, etc. can be used to link the device to the profile that is linked to a users TrustSocial account.

While certain embodiments have been described above, it will be understood that the embodiments described are by way of example only. Accordingly, the systems and methods described herein should not be limited based on the described embodiments. Rather, the systems and methods described herein should only be limited in light of the claims that follow when taken in conjunction with the above description and accompanying drawings.

We claim:

1. The systems and methods substantially as described herein.
